(19) United States
(12) Patent Application Publication
(10) Pub. No.: US 2026/0215372 A1
(43) Pub. Date: Jul. 30, 2026

(54) Agricultural Baler

(71) Applicant: AGCO Corporation, Duluth, GA (US)

(72) Inventor: Eric John Herbers, Hesston, KS (US)

(21) Appl. No.: 19/144,470

(22) PCT Filed: Nov. 30, 2023
(86) PCT No.: PCT/IB2023/062064

§ 371 Date: Jun. 28, 2025

Related U.S. Application Data
(60) Provisional application No. 63/477,614, filed on Dec. 29, 2022.

(51) Int. Cl. A01F 15/08; A01F 15/04

(52) U.S. Cl. CPC A01F 15/0825; A01F 15/042; A01F 15/046

(57) ABSTRACT

An agricultural baler comprising a baling chamber and reciprocating piston plunger operating within the baling chamber for compressing crop material is disclosed. The agricultural baler is provided with measurement apparatus located at a threshold location at each of the left and right hand sides of the baling chamber, the measurement apparatus being actuated to provide a time measurement when the piston plunger compresses the crop material and determining any difference between the time measurements. Any time difference between the time measurements is reflective of the loading of the piston plunger and can be used to determine which side of the face of the piston plunger is consistently loaded more, and so which side of the baling chamber needs to receive additional cut crop.

### FIELD

The present invention relates to a baler and related systems for detecting uneven loading of a baling chamber of the baler.

### BACKGROUND

It is known to collect cut crop, such as hay, straw or silage crop into a windrow on a field where the cut crop may subsequently be collected by an agricultural baler and processed into bales of cut crop. In a square baler, charges of cut crop are delivered by the pick up apparatus from the ground to a precompression chamber. The charges are then transferred from the precompression chamber to a baling chamber where the charges are compressed into flakes by the action of a reciprocating piston plunger. Successive flakes are created to form a parallelopiped bale within the baling chamber. Once the forming bale has reached a predetermined length a tying mechanism is operated to encircle the bale with strands of binding material and to knot the strands to form a finished bale which is subsequently ejected from the baler.

During operation of the baler it is desirable that the baling chamber is fed evenly with cut crop in order that straight bales are produced. It is known, in large square balers, typically high density balers, that an operator is provided with feedback to advise the operator whether to drive to the left or the right of the windrow in order to yield even formation of a bale. This is typically achieved by measuring a difference in load from the left to the right side of the piston plunger, for example by the use of force sensors either inside connecting rods of the piston plunger, incorporated into a gearbox mounting or incorporated into a frame of the agricultural baler near the gearbox mounts.

However, it is not economically feasible to use such force sensors in small square balers. There are also practical difficulties. Most small square balers only use a single connecting rod between the piston plunger and the gear box. This only allows for force to be measured at the plunger itself which is a difficult region in which to reliably measure force. As such it is typically the case that the operator of a small square baler must use their skill and judgement to ensure that even bales are produced.

It is an advantage of the present invention that it allows for the direction of the operator of a small square baler when baling.

### BRIEF SUMMARY

According to a first aspect of the present invention, an agricultural baler comprises a baling chamber, a reciprocating piston plunger operating within the baling chamber for compressing crop material and measurement apparatus located at a threshold location at each of the left and right hand sides of the baling chamber, the measurement apparatus being actuated to provide a time measurement when the piston plunger compresses the crop material and determining any difference between the time measurements at the left and right hand sides of the baling chamber.

Any time difference between the time measurements is reflective of the loading of the piston plunger and can be used to determine which side of the face of the piston plunger is consistently loaded more, and so which side of the baling chamber needs to receive additional cut crop.

Preferably, the measurement apparatus comprises sensors detecting the leading edge of the face of the piston plunger. Preferably such sensors may include optical sensors, inductive sensors or Hall effect sensors.

Alternatively, or additionally, the measurement apparatus comprises sensors actuated by the crop material compressed by the piston plunger. Preferably, such sensors comprise switches actuated by movement of hay dogs.

Preferably the measurement apparatus is located in an upper wall of the baling chamber.

Preferably the measurement apparatus is also located in the side walls of the baling chamber.

According to a second aspect of the invention a control system for controlling operation of one or more controllable components of an agricultural baler, the control system comprising one or more controllers, and being configured to: receive data indicative of a time measurement from measurement apparatus located at a threshold location when the piston plunger compresses crop material; determining, in dependence on the time measurement data, a directional strategy for collecting cut crop, the directional strategy including an indication of the direction the agricultural baler should be moved in response to the time measurement data; and generate and output one or more control signals for controlling one or more operational components associated with the baler in dependence on the determined directional strategy.

Preferably, the directional strategy comprises one of the following: move to the left, move to the right, or no change in direction required.

Preferably, the one or more operational components comprises a user interface, such as a display screen. The user interface may be operable to provide information indicative of the determined directional strategy to an operator of the baler. Preferably, the control system is configured to generate and output the one or more control signals for controlling operation of the user interface to display the determined baling strategy to an operator of the agricultural baler.

The one or more operational components may additionally comprise a drive means for controlling the direction of the agricultural apparatus towing the baler.

According to a third aspect of the invention; there is provided a system, comprising: an agricultural baler according to the first aspect of the invention; and a control system configured to direct operation of the agricultural baler in accordance with a determined directional strategy according to the second aspect of the invention.

Preferably, the system includes an agricultural vehicle towing the agricultural baler, the agricultural vehicle including the user terminal.

According to a fourth aspect of the invention a method of controlling operation of one or more operational components of an agricultural baler comprising the steps of: when a piston plunger compresses crop material receiving data indicative of a time measurement from measurement apparatus located at a threshold location within a baling chamber; determining, in dependence on the time measurement data, a directional strategy for collecting cut crop, the directional strategy including an indication of the direction the agricultural baler should be moved in response to the time measurement data; and generate and output one or more control signals for controlling one or more operational components associated with the baler in dependence on the determined directional strategy.

Preferably, the directional strategy comprised one of the following: move to the left, move to the right, or no change in direction required.

Preferably, the one or more operational components may comprise a user interface, such as a display screen. The user interface may be operable to provide information indicative of the determined directional strategy to an operator of the baler. Preferably, the control system may be configured to generate and output the one or more control signals for controlling operation of the user interface to display the determined baling strategy to an operator of the agricultural baler.

Alternatively, or additionally the one or more operational components comprises a drive means for controlling the direction of the agricultural apparatus towing the baler.

A further aspect of the invention provides computer software comprising computer-readable instructions which, when executed by a processor, cause performance of a method in accordance with the preceding aspect of the invention.

A yet further aspect of the invention provides a non-transitory computer readable storage medium comprising the computer software of the preceding aspect of the invention.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

The invention will now be described, by way of example only, with reference to the accompanying drawings, in which:

FIG. 1 shows a side view of a baler for use with the present invention;

FIG. 2 shows a sectional side view of the baler of FIG. 1;

FIG. 3 shows a schematic side view of a baling chamber of a baler in accordance with the present invention;

FIG. 4 shows a sectional view of a baling chamber of a baler in accordance with the present invention;

FIG. 5 shows an example hay dog for use as a sensor in accordance with the present invention;

FIG. 6 shows a diagrammatic representation of elements of a control system for the baler;

FIG. 7 shows a flow chart of the operation of a control system for the baler; and

FIG. 8 is a schematic diagram of a tractor-baler combination embodying aspects of the present invention.

### DETAILED DESCRIPTION

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

Relative terms such as forward, rearward, transverse, lateral, longitudinal and sideways will be made with reference to the normal forward direction of travel of the baler. The terms vertical and horizontal will be made with reference to level ground upon which the baler is disposed. The terms “upstream” and “downstream” are made with reference of the general direction of crop flow along the material conveyance systems described.

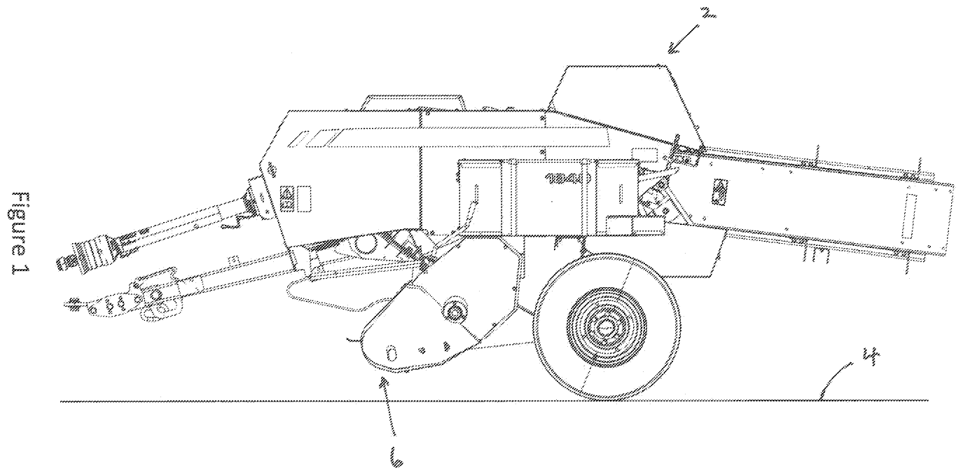

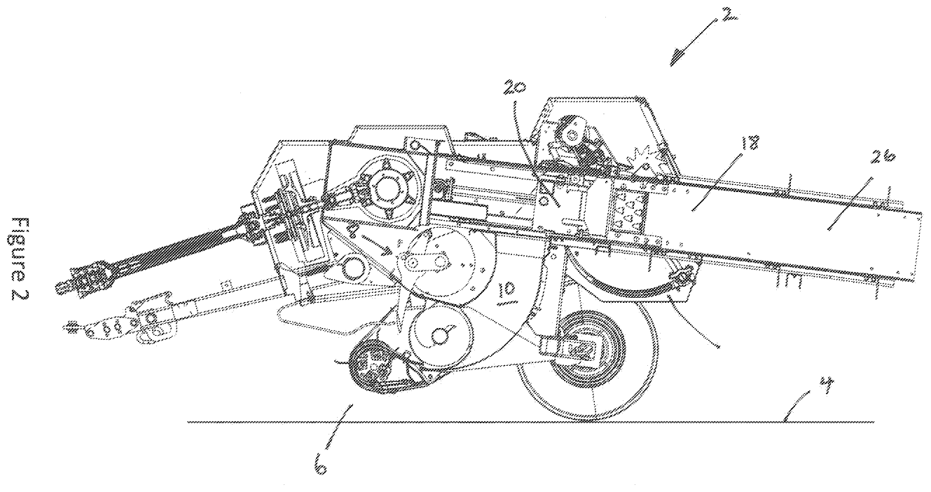

Referring first to FIGS. 1 and 2, an agricultural baler of the kind known as a small square baler is shown. The baler 2 is shown on flat ground 4. The baler 2 includes a pick up unit 6 to gather cut crop from a windrow of cut crop lying on the ground 4. A stuffer unit 8 directs the crop into a precompression chamber 10 to form a charge of cut crop.

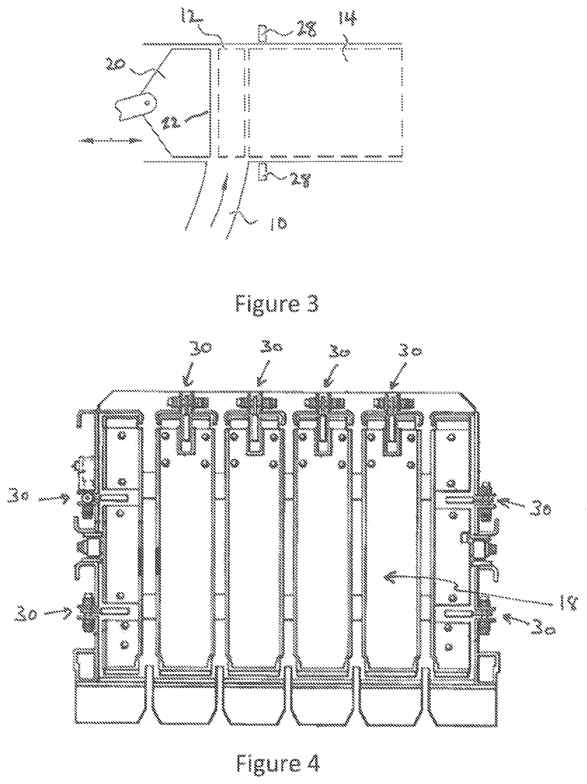

Moving in a forwards direction, the baler 2 is operable to gather loose cut crop material, form it into an individual charge 12 of cut crop, and following introduction of the charge 12 of cut crop through an opening in a bottom wall of the baling chamber 18, compress the individual charge into a flake with additional such flakes to form a bale 14. A baling system may broadly comprise a towing agricultural vehicle 16, such as a tractor, and the baler 2 (FIG. 8). The tractor may include a cab wherein an operator may located; an engine operable to move the towing agricultural vehicle; a steering mechanism to control the direction of travel of the towing vehicle and a Power Take Off arrangement (PTO) operable to transfer mechanical power from the engine to the baler or other connected machinery. The baler 2 may broadly comprise a frame mechanically coupled with the towing agricultural vehicle 16; a loose crop material receiving and stuffing component as noted above; a baling chamber 18; and a reciprocating plunger 20 having a plunger face 22 (see also FIG. 3).

The plunger 20 moves in a reciprocating manner within the baling chamber 18 from a front-dead-center position in which the plunger face 22 of the plunger 20 is furthest from the forming bale to a rear-dead-center position in which the plunger face 22 is compressing the forming bale. More specifically, the plunger 20 repeatedly extends into the baling chamber 18 such that the plunger face 22 contacts and compresses the charge 12 and the flakes that are already present therein, and retracts to allow the next charge 12 to enter the baling chamber 18 from the precompression chamber 10.

The baling system may further comprise one or more electronic control units or processors 50. Typically, the baling system comprises a processor associated with the baler 2 and a processor associated with the towing agricultural vehicle 14. However, a single processor may be used. The processors communicate with one another and other electrical components, as will be described below, by way of any suitable communications network 56.

The baling chamber 18 of the baler 2 is adapted to receive the charge of cut crop through the bottom wall of the baling chamber 18 when the plunger face 22 is travelling forwards (towards the towing agricultural vehicle 14) so that the charge of cut crop is in position to be compressed by the plunger face 22 into a flake on the return stroke of the plunger 20. BY generating multiple flakes in this way a bale 16 is formed. The baling chamber 18 is conveniently substantially rectangular in shape in order to facilitate the compression and forming process. The plunger 20 is operable to compress the charge 12 into the forming bale by moving within the baling chamber 18. Once the forming bale has reached a desired size, a tying mechanism 24 is operated to encircle the bale with strands of binding material and to knot the strands to form a finished bale which is subsequently ejected from the baler by way of a chute 26 at a rear end of the baling chamber 18.

It has been appreciated that a coarse load difference can be estimated by measuring the difference in time between the left and right hand sides of the plunger 20 crossing a threshold location. Due to uneven load distribution it is understood that the plunger face 22 will deform slightly with more deformation being on the side that sees a higher load. As such there is a very small delay in which that side of the plunger face 22 may cross a given threshold location near the rear of the stroke when the plunger face 22 is compressing the forming bale 14. This time difference between the left and right sides can measured to determine which side is consistently loaded more or if the loading is even.

In a first example, measurement apparatus is located in the region of the rear-dead-center position in which the plunger face 22 is compressing the forming bale. In this example the sensors detect the transition from any compressed crop material to the face of the plunger. Any suitable measurement apparatus may be used, for example optical sensors, induction sensors or Hall effect sensors.

The position of the plunger face 22 of the plunger 20 as it reaches the in the region of the rear-dead-center position is detected by sets of such sensors 28. The sensors 28 may be arranged within the upper and lower walls of the baling chamber 18 to each side of the plunger face 22 (FIG. 3). As the plunger face 22 crosses the sensors 28, the sensors 28 generate time measurement data signals that are communicated to an electronic control unit 50.

The electronic control unit 50 is also in electronic communication with a user terminal 52. Typically, the user terminal 52 may be located in the operator's cab of the towing vehicle 16. The electronic control unit 50 can generate control signals to the user terminal 52 to cause the user terminal 52 to communicate with or indicate to an operator either which side of the baling chamber is overloaded (if either) or to indicate in which direction the towing vehicle 16 (and the towed baler 2) should be driven to address any overloading.

The electronic control unit 50 also has access to a memory 54. The memory 54 may conveniently store values associated with threshold values of the time difference between time measurement data signals from each of the left and right hand sides of the baling chamber 18, such that the time difference recorded between these signals will need to exceed a predetermined value before the electronic control unit 50 executes an instruction to generate a suitable control signal. The electronic control unit 50 can interpret a positive or negative time difference between the time measurement data signals as representative of overloading on one side or the other of the plunger face 22 and executes an instruction to generate the suitable control signal.

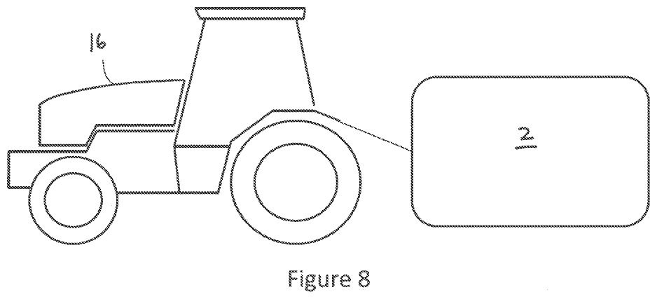

In summary, the sensors 28 send time measurement data signals to an electronic control unit 50 when the piston plunger compresses the crop material. The electronic control unit 50 receives these signals (step 100, FIG. 7). The electronic control unit 52 compares these signals with data stored in the memory (step 102) and then generates a suitable control signal (step 104). The electronic control unit 52 then awaits the next set of time measurement data signals.

In a further example, the electronic control unit 50 may generate a control signal to control the steering apparatus of the towing vehicle 16 to ensure that the baler 2 moves across the windrow in a desired fashion. This control signal may be instead of or in addition to the control signal to the user terminal 52.

In a second example, the operation of hay dog assemblies 30 is used to provide the time measurement when the piston plunger compresses the crop material. In this example the threshold location will be understood to located in the baling chamber behind the rear-dead-center position of the plunger 20.

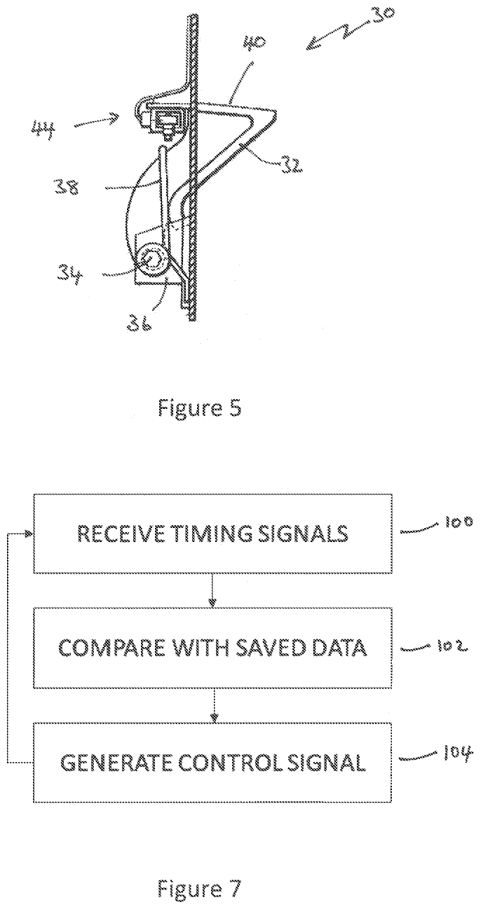

An example set of hay dog assemblies are shown by reference to FIGS. 4 and 5. In the illustrated embodiment, a pair of hay dog assemblies 30 are mounted to each side wall and a set of similar hay dog assemblies 30 are mounted to the top wall to each side of the baling chamber. The hay dog assemblies 30, as explained below, retain the most recently formed flake after its compression by the plunger 20 in order to prevent forward expansion of the compressed flake of crop material within the baling chamber 18 while the plunger 20 is retracting. Each hay dog assembly 30 comprises a hay dog 32 comprising a suitably shaped pivotable member projecting through a longitudinal slot in one of the side walls of the baling chamber 18.

As best shown in FIG. 5, each hay dog 32 is mounted for pivoting movement about the shaft of vertical bolt 34 which is mounted through lugs 36 affixed to the outside of the baling chamber wall. A torsion spring 38 mounted on the bolt 34 has one end resting against the side wall of the baling chamber 18 and another against an outer rim of the hay dog 32. The torsion spring 38 acts to force the hay dog 32 inwardly into the baling chamber 18. The hay dog 32 has a forward edge extending at an acute angle from the side wall and a rearward edge 40 extending at a substantially right angle from the side wall when the hay dog is in its rest position as shown in FIG. 5. The hay dog assemblies 30 are mounted such that the rearward edges 40 of the hay dogs 32 are positioned in alignment with or slightly in front of the hindmost position of the plunger face 22 during the compression stroke of the plunger 20.

The hay dogs 32 are received in a series of longitudinal slots 42 in the sides of the baling chamber such that they are not engaged by the plunger 20 during each stroke of the plunger mechanism. Consequently, when no fresh crop material is introduced into the baling chamber 18 and the baler is running idle, the hay dogs remain in their inward position shown in FIG. 5.

However, when the stuffer mechanism 8 introduces a new charge 12 of crop material into the baling chamber 18, the charge 12 of crop material will be engaged by the plunger face 22 and shoved rearwardly along the hay dogs 32. The crop slides along the forward edge of the hay dogs 32 and pushes the latter outwardly. At the end of the compression stroke, when all crop material has been shoved beyond the hay dog assemblies 30, the action of the torsion springs 38 brings the hay dogs 32 back to their rest positions. When the plunger 20 retracts and starts travelling forwardly again, the compressed package of crop material tends to dilate and its front face expands in the direction of the plunger 20. However, the compressed crop material is held back by the rear edges 40 of the hay dogs 32 on the left and right hand sides of the baling chamber 18. Consequently, the front face of the forming bale 14 is stabilized and the inlet opening in the bottom wall of the baling chamber 18 will not be blocked, such that further charges of crop material may be introduced into the baling chamber 18 without hindrance.

The hay dog assemblies 30 in the top wall are similar in structure and operation and are not described further.

The movement of the hay dog assemblies 30 is indicative of an introduction of a fresh charge of crop material into the baling chamber. This movement is sensed by means of a switch 44, which is mounted to a vertical support plate adjacent each hay dog 32 on the appropriate baling chamber wall (FIG. 5). The switch 44 is engaged by the hay dog 32 when pushed outwardly by a new charge 12 of crop material passing along this portion of the baling chamber wall. The passage of the charge of crop material along each portion of the baling chamber wall which is equipped with a hay dog assembly 30, triggers the switch 44.

It will be understood that the actuation of the switches 44 by the hay dogs 32 will be dependent on the density of the crop material in the region of each hay dog. In an extreme case if no, or insufficient, crop material has been introduced to the baling chamber in the region of a hay dog 32, the hay dog will not move and the switch 44 will not be actuated.

As in the previous example, the switches 44 send time measurement data signals to an electronic control unit 50. The electronic control unit 50 compares these signals with data stored in the memory and then generates a suitable control signal. The electronic control unit 52 then awaits the next set of time measurement data signals. If no time measurement data signal is detected by the electronic control unit 50 (because the switch has not been actuated) this will be treated by the electronic control unit 50 a representative of a time measurement data signal indicating the absence of crop material in the threshold location.

In a further example, the electronic control unit 50 may generate a control signal to control the steering apparatus of the towing vehicle 16 to ensure that the baler 2 moves across the windrow in a desired fashion. This control signal may be instead of or in addition to the control signal to the user terminal 52.

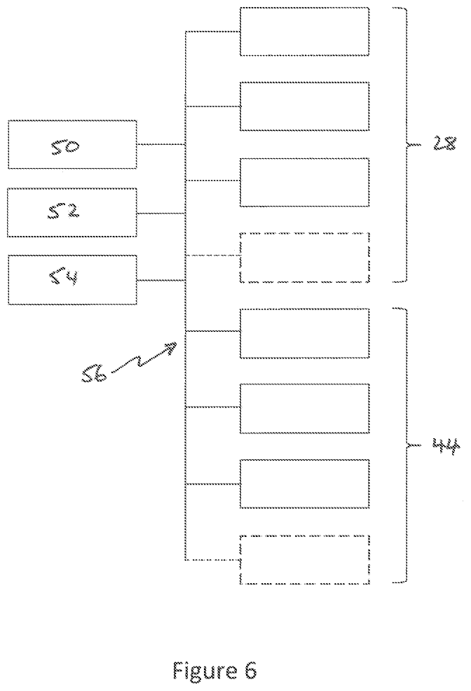

In a further example the electronic control unit may process signals both from the hay dog switches and from sensors detecting the face 22 of the piston plunger 20 before issuing a control signal to the user terminal or the steering mechanism (for example as in the arrangement shown in FIG. 6).

All references cited herein are incorporated herein in their entireties. If there is a conflict between definitions herein and in an incorporated reference, the definition herein shall control.

From reading the present disclosure, other modifications will be apparent to persons skilled in the art. Such modifications may involve other features which are already known in the field of square balers and component parts therefore and which may be used instead of or in addition to features already described herein.

1. An agricultural baler comprising a baling chamber, a reciprocating piston plunger operating within the baling chamber for compressing crop material and measurement apparatus located at a threshold location at each of the left and right hand sides of the baling chamber, the measurement apparatus being actuated to provide a time measurement when the piston plunger compresses the crop material and determining any difference between the time measurements at the left and right hand sides of the baling chamber.

2. An agricultural baler according to claim 1, characterized in that the measurement apparatus comprises sensors detecting the leading edge of the face of the piston plunger, for example optical sensors, inductive sensors or Hall effect sensors.

3. An agricultural baler according to claim 1, characterized in that the measurement apparatus comprises sensors detecting the presence of crop material in the baling chamber behind a rear-dead-center position of the plunger, for example switches actuated by movement of hay dogs located within the baling chamber.

4. An agricultural baler according to claim 1, characterized in that the measurement apparatus is located in an upper wall of the baling chamber.

5. An agricultural baler according to claim 4 in which the measurement apparatus is also located in the side walls of the baling chamber.

6. A control system for controlling operation of one or more controllable components of an agricultural baler, the control system comprising one or more controllers, and being configured to: receive data indicative of a time measurement from measurement apparatus located at a threshold location when the piston plunger compresses crop material; determining, in dependence on the time measurement data, a directional strategy for collecting cut crop, the directional strategy including an indication of the direction the agricultural baler should be moved in response to the time measurement data; and generate and output one or more control signals for controlling one or more operational components associated with the baler in dependence on the determined directional strategy.

7. A control system according to claim 6, characterized in that the directional strategy comprises one of the following: move to the left, move to the right, or no change in direction required.

8. A control system according to claim 6, characterized in that the one or more operational components comprises a user interface, such as a display screen.

9. A control system according to any of claim 6 to claim 8, characterized in that the user interface is operable to provide information indicative of the determined directional strategy to an operator of the baler.

10. A control system according to claim 6, characterized in that the control system is configured to generate and output the one or more control signals for controlling operation of the user interface to display the determined baling strategy to an operator of the agricultural baler.

11. A control system according to claim 6, characterized in that the one or more operational components comprises a drive means for controlling the direction of the agricultural apparatus towing the baler.

12. A system, comprising: an agricultural baler according to claim 1, and a control system configured to direct operation of the agricultural baler in accordance with a determined directional strategy.

13. A system according to claim 12, characterized in that the system includes an agricultural vehicle towing the agricultural baler, the agricultural vehicle including the user terminal.

14. A method of controlling operation of one or more operational components of an agricultural baler comprising the steps of: when a piston plunger compresses crop material receiving data indicative of a time measurement from measurement apparatus located at a threshold location within a baling chamber; determining, in dependence on the time measurement data, a directional strategy for collecting cut crop, the directional strategy including an indication of the direction the agricultural baler should be moved in response to the time measurement data; and generate and output one or more control signals for controlling one or more operational components associated with the baler in dependence on the determined directional strategy.

15. A method according to claim 14, characterized in that the directional strategy comprises one of the following: move to the left, move to the right, or no change in direction required.

16. A method according to claim 14, characterized in that one or more operational components comprises a user interface, such as a display screen.

17. A method according to claim 14, characterized in that the user interface is operable to provide information indicative of the determined directional strategy to an operator of the baler.

18. A method according to claim 14, characterized in that the control system is configured to generate and output the one or more control signals for controlling operation of the user interface to display the determined baling strategy to an operator of the agricultural baler.

19. A method according to claim 14, characterized in that the one or more operational components comprises a drive means for controlling the direction of the agricultural apparatus towing the baler.

20. Computer software comprising computer-readable instructions which, when executed by a processor, cause performance of a method in accordance with claim 14.

21. (canceled)
